(19) United States
(12) Patent Application Publication
(10) Pub. No.: US 2015/0213136 A1
(43) Pub. Date: Jul. 30, 2015

(54) Method and System for Providing a Personalized Search List

(71) Applicant: 1 Verge Internet Technology (Beijing) Co., Ltd., Beijing (CN)

(72) Inventors: Xiuguang Tan, Beijing (CN); Jian Yao, Beijing (CN); Yuzong Yin, Beijing (CN); Wei Lu, Beijing (CN); Baiyu Pan, Dongfang City (CN); Shuqi Lu, Beijing (CN)

(21) Appl. No.: 14/420,894

(22) PCT Filed: Aug. 30, 2013
(86) PCT No.: PCT/CN2013/082748

§ 371 Date: Feb. 10, 2015

(30) Foreign Application Priority Data
Oct. 12, 2012 (CN) 201210385868.9

(51) Int. Cl. G06F 17/30; H04L 29/08

(52) U.S. Cl. CPC G06F 17/30867; H04L 67/22

(57) ABSTRACT

Disclosed herein is a method and system for providing a personalized search list, which comprises: recording a viewing log of a user based on the user's viewing activities of network videos; analyzing the recorded viewing log at a cloud server to generate a list of network videos that the user may like, wherein the list of network videos the user may like comprises a list of network videos based on the user information, or a list of network videos based on the contents of network videos viewed by the user, or a list of network videos based on a degree of viewing similarity between the user and other users, or combination thereof. After a list of search results are generated in response to a user-entered search term, an intersection between the list of search results and the list of network videos that the user may like is calculated to provide the personalized search list.

### FIELD OF THE INVENTION

The present invention generally relates to the field of online video search, and more particularly, to a method and system for providing a personalized search list.

### BACKGROUND

A user's viewing records at those websites for viewing network videos usually provide an accurate reflection of the user's viewing interest. However, most existing network video websites do not record such data. Although some websites keep a record of users' viewing history, the record is kept for only a short period of time and with no visibility to users, in which case no user can really keep track of his/her own viewing details. In addition, without such complete user viewing records, no search engine can fully analyze a user's viewing interests or provide the user with a personalized search service. To solve this problem, the present invention provides a system that records the user viewing history every time after the user conducts a search for network videos, and based on the viewing data, analyzes the user's viewing behavior and provides the user with a customized network video search service. Also, according to the system configuration, certain complex tasks such as data storage, aggregation, identification, classification and intelligent notification are performed at a cloud server, thereby optimizing local experiences.

### SUMMARY OF THE INVENTION

The presently disclosed embodiments are directed to solving issues relating to one or more of the problems presented in the prior art, as well as providing additional features that will become readily apparent by reference to the following detailed description when taken in conjunction with the accompanying drawings.

One embodiment of the invention provides a method for providing a personalized search list, comprising: recording a viewing log of a user based on the user's network video viewing activities; using a cloud server to analyze the recorded viewing log to obtain a list of network videos that the user may like, wherein the list of network videos that the user may like comprises a first list of network videos based on information of the user, or a second list of network videos based on contents of network videos viewed by the user, or a third list of network videos based on a degree of viewing similarity between the user and other users; generating a list of searched videos based on a search term by the user; and determining an intersection between the list of searched videos and the list of network videos that the user may like, wherein the intersection is provided to the user as a personalized search list.

In one embodiment, the first list of network videos based on information of the user is obtained by: dividing a plurality of users into groups based on user information including a gender, age, region and educational background of each user; and for each group of users, calculating a union of network video collections that each user has viewed to obtain a collection C, wherein C represents network videos that all users in the group may like.

In another embodiment, the second list of network videos based on contents of network videos viewed by the user is generated by determining whether the user likes a certain type of network videos, and if so, listing all network videos of the same type on the second list of network videos.

In yet another embodiment, the third list of network videos based on a degree of viewing similarity between the user and other users is generated by: for all users m1, m2, m3, . . . mn and their corresponding collections of viewed network videos, A1, A2, A3, . . . , calculating a degree of viewing similarity si between any two users, wherein si=A1∩Ai/A1; for each user, after acquiring all degrees of viewing similarity between the user and all other users, calculating

$$sii = \frac{1}{n} {\sum }_{i = 1}^{n} si ,$$

wherein n representing the number of users; and determining if the degree of similarity between users m1 and m2 is greater than sii, and if so, listing all network videos viewed by the user m2 as network videos that the user m1 may like, and all network videos viewed by the user m1 as network videos that the user m2 may like.

Another embodiment of the invention provides a system for providing a personalized search list, comprising: a recording apparatus configured for recording a viewing log of a user based on the user's network video viewing activities; a cloud server configured for analyzing the recorded viewing log to generate a list of network videos that the user may like, wherein the list of network videos that the user may like comprises a first list of network videos based on information of the user, or a second list of network videos based on contents of network videos viewed by the user, or a third list of network videos based on a degree of viewing similarity between the user and other users; an intersection module configured for acquiring a list of searched videos based on a search term from the user, determining an intersection between the list of searched videos and the list of network videos that the user may like, and providing the intersection to the user as a personalized search list.

In one embodiment, the first list of network videos based on information of the user is obtained by: dividing a plurality of users into groups based on user information including a gender, age, region and educational background of each user; for each group of users, calculating a union of network video collections that each user has viewed to obtain a collection C, wherein C represents network videos that all users in the group may like.

In another embodiment, the second list of network videos based on contents of network videos viewed by the user is generated by determining whether the user likes a certain type of network videos, and if so, listing all network videos of the same type on the second list of network videos.

In yet another embodiment, the third list of network videos based on a degree of viewing similarity between the user and other users is generated by: for all users m1, m2, m3, . . . mn and their corresponding collections of viewed network videos, A1, A2, A3, . . . , calculating a degree of viewing similarity si between any two users, wherein si=A1∩Ai/A1; for each user, after acquiring all degrees of viewing similarity between the user and all other users, calculating

$$sii = \frac{1}{n} {\sum }_{i = 1}^{n} si ,$$

wherein n representing the number of users; and determining if the degree of similarity between users m1 and m2 is greater than sii, and if so, listing all network videos viewed by the user m2 as network videos that the user m1 may like, and all network videos viewed by the user m1 as network videos that the user m2 may like.

In view of the problems in the existing art, one embodiment of the invention provides Embodiments of the present invention provide the following advantage: by calculating weight values of different dimensions, the present invention places the search results more needed by users in the top of a web page, thereby providing a more accurate display of the user-desired search results and improved viewing experience.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a block diagram that demonstrates a personalized list of video recommendations by analyzing specific users according to embodiments of the present invention;

FIG. 2 is a block diagram that demonstrates a personalized list of video recommendations by analyzing network video contents according to embodiments of the present invention; and

FIG. 3 is a flow diagram illustrating an analyzing algorithm according to embodiments of the present invention.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, embodiments of the present invention are not intended to be limited to the examples described herein and shown, but is to be accorded the scope consistent with the claims.

The actual implementation of embodiments of the present invention consists of three parts as will be described below.

1. Recording a user's viewing logs.

Currently most mainstream web browsers provide for function scalability in the plug-in form, and by use of the plug-ins, can collect browser-related log information. The plug-in client of this system generally records a user's viewing history of network videos. It allows for two types of recording, i.e. automatic recording and manual recording, as well as other functions such as annotating and scoring network videos. The automatic recording is implemented as follows: the plug-in client first analyzes the behavior of the current browser. If a user is visiting a network video website and if the website pertains to the data range collected by this plug-in, the plug-in would automatically analyze the network video playing page, and send related network video information to a cloud server. The manual recording is implemented as follows: when a user wants to collect certain network video information, he clicks a functional button provided by the plug-in, then the plug-in client would automatically obtain the information of the network video being viewed and present the information to the user. Then the user can modify or add to the information. After the data editing is confirmed, the user can activate a data storage command to send the data to the cloud server for storage. In manual recording, a user can perform naming, memo, scoring and any other operation. Any data derived from these operations can also be sent to the cloud server for permanent storage so that the user can easily access and browse at anytime and anywhere.

2. Analyzing the viewing log data at a cloud server

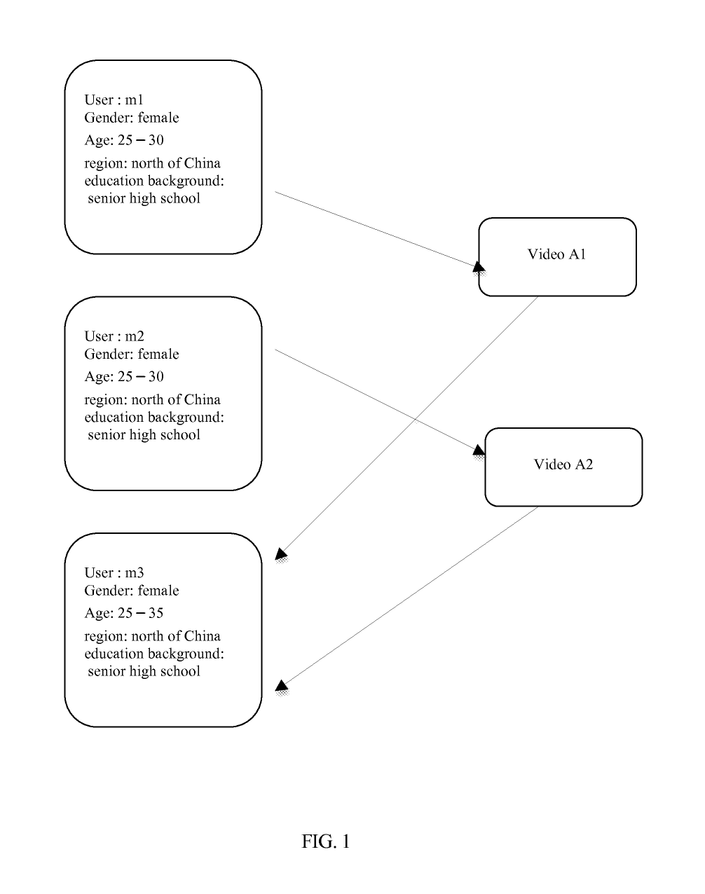

The cloud server is generally used to collect and store user viewing records sent from the client browser. Meanwhile, the server is configured to ensure data security with any loss or leak of such records. Each user's viewing records are analyzed in order to obtain network videos that may be interesting to the user, which would be recommended to the user during the user's search for network videos. There are generally three ways to obtain those videos of potential interest to the user: one is based on the user information, one is based on the network video content, and another one is based on the degree of similarity of the viewed network videos. The user-based method for generating the network videos that a user may is shown in FIG.1. As shown in FIG. 1, the first step is divide users into different groups based on the user information collected by the system. For example, the collected user information generally comprises gender, age, region, educational background, wherein the age is further divided into units of every 10 years, the region is divided into the south and north of China, the educational background is divided into primary school (including educational degree below primary school), junior high school, senior high school, university, master, and doctor (including educational degree above doctor), and the gender is divided into male and female. Assuming that the final groups include g1, g2, g3, . . . gn, and assuming that each user m1, m2, m3, . . . mn in any one of these groups likes (or has selected to view) the following network videos sets or collections: A1, A2, A3, . . . , An, respectively, calculating the union of A1, A2, A3, . . . An results in a set C, which is the network videos that all users in the group may like. As an example, if user m1 likes the network video A1, and the user m2 likes the network video A2, where user m1 is female, whose age is between 25 and 30, region in the north of China, and educational background senior high school, and user m2 is female, whose age is between 30 and 35, region the north of China, and educational background senior high school, then for user m3, who's female, age between 25 and 35, and with the same region and educational background, the network videos A1, A2 may be recommended to the user m3 as the ones she may like.

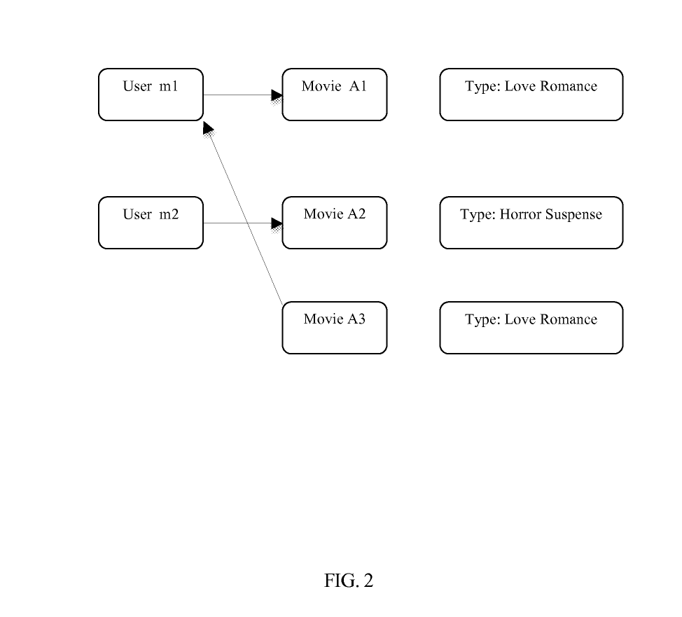

Another method based on the network video content is shown in FIG.2. As shown in FIG. 2, if assuming that user m1 likes (or has selected to view) movie A1 in the genre of love and romance, user m2 likes movie A2 in the genre of horror and suspense, then movie A3 in the genre of love and romance may be recommended to user m1 rather than m2.

The third method based on the degree of similarity of network videos that the user has viewed works as follows: for all the users m1, m2, m3, . . . mn and their corresponding viewing history, namely, a network video collection A1 viewed by user m1, a network video collection A2 viewed by the user m2, a network video collection A3 viewed by the user m3, and a network video collection An viewed by the user mn, there is a degree of viewing similarity between every two users, indicated by si=A1∩Ai/A1 (∩ representing the number of collections after intersection). For any given user, after the degrees of viewing similarity between him/her and all other users are calculated, the next step is to compute

$$sii = \frac{1}{n} {\sum }_{i = 1}^{n} si$$

wherein n represents the number of all users. If the degree of similarity between user m1 and user m2 exceeds sii, then presumably user m2 may like all the network videos that user m1 likes, and vice versa. For example, if user m1 has viewed three network videos a, b, and c, and user m2 has viewed three network videos b, c, and d, the degree of similarity between users m1 and m2 is ⅔. If this degree of similarity is greater than sii, it can be assumed that user m1 likes the network video d viewed by user m2, and user m2 likes the network video a viewed by user m1.

3. Combining recommended videos with the network video search results

For each user, the process after the above step 2 of analysis may generate a set of network videos A that the user may like. When the user performs an online search of videos, the search results are shown as another set of network videos B. As such, the intersection C between set A and set B would be a personalized list of recommended videos for final display to the user.

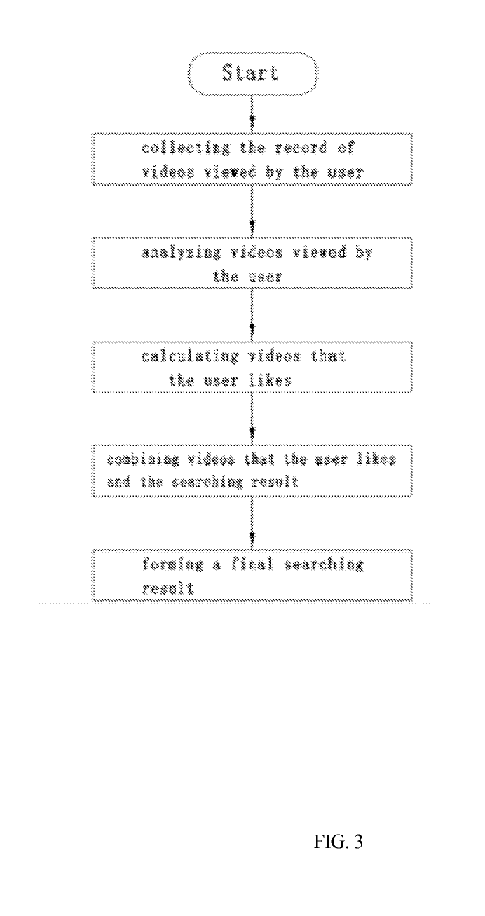

As shown in the flow chart in FIG. 3, the present invention generates a final list of recommended videos by collecting, analyzing, calculating, and merging various types of data. Specifically, the algorithm according to embodiments of the invention includes the following steps: recording a viewing history or log of a user based on the user's network video viewing activities; at a cloud server analyzing the recorded viewing logs to generate a list of network videos that the user may like, wherein the list of network videos can be a list of network videos based on the user information, or a list of network videos based on the content of viewed network videos, or a list of network videos based on a degree of viewing similarity, or a combination thereof; generating a list of network videos as results in response to a search term by the user; and identifying an intersection between the list of network videos as search results and the list of network videos that the user may like and providing the intersection as a personalized search list.

The present invention also provides a system for providing a personalized search list, which includes the following components: a recording apparatus for recording a viewing log of an user based on the user's viewing activities with network videos; a cloud server for analyzing the recorded viewing log to generate a list of network videos that the user may like, wherein the list of network videos is a list of network videos based on the user information, or a list of network videos based on the content of viewed network videos, or a list of network videos based on the degree of viewing similarity, or a combination thereof; an intersection module for acquiring a list of searched videos in response to a search term of the user, determining an intersection between the list of searched videos and the list of network videos that the user may like, and providing the intersection as the personalized search list.

In the above-mentioned process and system, the list of network videos based on the user information is generated as follows: dividing the users into groups based on the collected user information, including gender, age, region and educational background of each user; calculating the union of the network videos in any group that each user likes to obtain a resulting video set C, which is the network videos in this group that all users may like.

Another way to generate the list network videos is based on the content of network videos. If a user likes a certain type of network video, all the network videos of the same type may be interesting to the user and thus are listed in the recommended list of network videos.

The above-described list of network videos that a user may like can also be acquired based on the degree of viewing similarity between the user and other users. In this method, for all the users m1, m2, m3, . . . mn and their corresponding viewing history, namely, a network video collection A1 viewed by user m1, a network video collection A2 viewed by the user m2, a network video collection A3 viewed by the user m3, and a network video collection An viewed by the user mn, there is a degree of viewing similarity between every two users, indicated by si=A1∩Ai/A1 (∩ representing the number of collections after intersection). For any given user, after the degrees of viewing similarity between him/her and all other users are calculated, the next step is to compute

$$sii = \frac{1}{n} {\sum }_{i = 1}^{n} si$$

wherein n represents the number of all users. If the degree of similarity between user m1 and user m2 exceeds sii, then presumably user m2 may like all the network videos that user m1 likes, and vice versa.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

What is claimed is:

1. A method for providing a personalized search list, comprising:
recording a viewing log of a user based on the user's network video viewing activities;
using a cloud server to analyze the recorded viewing log to obtain a list of network videos that the user may like, wherein the list of network videos that the user may like comprises a first list of network videos based on information of the user, or a second list of network videos based on contents of network videos viewed by the user, or a third list of network videos based on a degree of viewing similarity between the user and other users;
generating a list of searched videos based on a search term by the user; and
determining an intersection between the list of searched videos and the list of network videos that the user may like, wherein the intersection is provided to the user as a personalized search list.

2. The method of claim 1, wherein the first list of network videos based on information of the user is obtained by:
dividing a plurality of users into groups based on user information including a gender, age, region and educational background of each user;
for each group of users, calculating a union of network video collections that each user has viewed to obtain a collection C, wherein C represents network videos that all users in the group may like.

3. The method of claim 1, wherein the second list of network videos based on contents of network videos viewed by the user is generated by determining whether the user likes a certain type of network videos, and if so, listing all network videos of the same type on the second list of network videos.

4. The method of claim 1, wherein the third list of network videos based on a degree of viewing similarity between the user and other users is generated by:
for all users m1, m2, m3, . . . mn and their corresponding collections of viewed network videos, A1, A2, A3, . . . , calculating a degree of viewing similarity si between any two users, wherein si=A1∩Ai/A1;
for each user, after acquiring all degrees of viewing similarity between the user and all other users, calculating
$$sii = \frac{1}{n} {\sum }_{i = 1}^{n} si ,$$
wherein n representing the number of users; and
determining if the degree of similarity between users m1 and m2 is greater than sii, and if so, listing all network videos viewed by the user m2 as network videos that the user m1 may like, and all network videos viewed by the user m1 as network videos that the user m2 may like.

5. A system for providing a personalized search list, comprising:
a recording apparatus configured for recording a viewing log of a user based on the user's network video viewing activities;
a cloud server configured for analyzing the recorded viewing log to generate a list of network videos that the user may like, wherein the list of network videos that the user may like comprises a first list of network videos based on information of the user, or a second list of network videos based on contents of network videos viewed by the user, or a third list of network videos based on a degree of viewing similarity between the user and other users;
an intersection module configured for acquiring a list of searched videos based on a search term from the user, determining an intersection between the list of searched videos and the list of network videos that the user may like, and providing the intersection to the user as a personalized search list.

6. The system of claim 5, wherein the first list of network videos based on information of the user is obtained by:
dividing a plurality of users into groups based on user information including a gender, age, region and educational background of each user;
for each group of users, calculating a union of network video collections that each user has viewed to obtain a collection C, wherein C represents network videos that all users in the group may like.

7. The system of claim 5, wherein the second list of network videos based on contents of network videos viewed by the user is generated by determining whether the user likes a certain type of network videos, and if so, listing all network videos of the same type on the second list of network videos.

8. The system of claim 5, wherein the third list of network videos based on a degree of viewing similarity between the user and other users is generated by:
for all users m1, m2, m3, . . . mn and their corresponding collections of viewed network videos, A1, A2, A3, . . . , calculating a degree of viewing similarity si between any two users, wherein si=A1∩Ai/A1;
for each user, after acquiring all degrees of viewing similarity between the user and all other users, calculating
$$sii = \frac{1}{n} {\sum }_{i = 1}^{n} si ,$$
wherein n representing the number of users; and
determining if the degree of similarity between users m1 and m2 is greater than sii, and if so, listing all network videos viewed by the user m2 as network videos that the user m1 may like, and all network videos viewed by the user m1 as network videos that the user m2 may like.
